(19) United States
(12) Patent Application Publication
(10) Pub. No.: US 2020/0311560 A1
(43) Pub. Date: Oct. 1, 2020

(54) Integrated Intelligence Systems and Processes

(71) Applicant: Ali G. Magin, Durham, NC (US)

(72) Inventor: Ali Giovanni Magin, Gainesville, FL (US)

(73) Assignee: Ali Giovanni Magin, Durham, NC (US)

(21) Appl. No.: 16/365,400

(22) Filed: Mar. 26, 2019

(51) Int. Cl. G06N 5/02; G06F 16/2455

(52) U.S. Cl. CPC G06N 5/02; G06F 16/2455

(57) ABSTRACT

Integrated Intelligence (ii) is disclosed, a technology for optimal, dynamic and distributed (in time and space) auto-decisioning to flexibly consider interactions with almost arbitrary number of factors and trade-offs in an enterprise. Such technology is beyond Business Intelligence (BI) tools, decision support suites/systems or enterprise planning systems or similar, as we know them today. An ii system would swap the roles of humans and machines in decision analysis and setting control variables, etc. Human experts would support the artificial intelligence (AI) in analyses that it needs to carry out to determine optimal choices instead of it being the other way around. Implementation and operation of such a technology creates a much higher demand for useful and complementary human judgements which are input to the system. These systems can systematically be attached or detached to expand or reduce their scope, and to integrate or disintegrate their intelligence (not just their data as in integrated systems but their tradeoffs and objectives).

### TECHNICAL FIELD

Field of this invention concerns artificial intelligence as it applies to the creation of an autonomous enterprise, where decision making is streamlined by AI to optimize for the ultimate objectives of the enterprise.

### BACKGROUND ART

The concept of an autonomous enterprise is one that is vaguely defined in public literature, sometimes associated with the term industry 4.0 (or x.0), that is to employ various cutting-edge technologies such as artificial intelligence (AI), robotics, AR/VR, IOT to automate many processes an enterprise has to go through manually and with costly interruptions. This disclosure is mainly concerned with the AI element of such automation and more specifically, with decision making processes of various types and at various levels of the enterprise.

Existing research and technologies are all limited to a single prediction, prescription of decision given a model and an associated set of information. The current disclosure considers a plurality of decisions and how they all may interact and be integrated towards the ultimate objectives of the single enterprise they all serve.

### SUMMARY OF INVENTION

### Technical Problem

The goal of virtually any business, is to maximize its profits, improve its service level and ideally grow its business. That means moving towards “optimal” choices, decision and execution ranging from operational and tactical to strategic decisions. Considering “optimality” forces one to see that there are cross-interactions amongst operations, finance, and management including various subparts of each. Yet, traditionally each of these areas are analyzed and improved separately. This separate treatment and use of many heuristics and good practices are all necessary to manage the enormous complexity of the system as a whole. However, the more complex, dynamic and variable the business environment, the further the result of these common practices will be from optimal (be it highest margins, lowest cost structure, etc.)

All current approaches and solutions to these problems are 1) not sufficiently dynamic and 2) are a collection of isolated solutions. Not sufficiently dynamic refers to the ubiquitous process of train, test, deploy of AI solutions. Collection of isolated solutions refers to a collection of isolated models that may share information but not their internal intelligence and the ability to modify one another in order to account for trade-offs present considering the whole system containing their larger collective environment.

In this invention it is recognized the technology that can truly enable an autonomous enterprise of arbitrary kind cannot follow the same practices as mentioned above. To that end, it is claimed here that the correct solution must possess the following three features simultaneously:

Scalability (same process and methodology has to be applicable to small as well as large size problem)
Universality (same process and methodology has to be applicable to various kinds of enterprises)
Modularity. (same process and methodology has to be applicable to various kinds of functionality within the enterprise and it should be able to function in pieces independently, not just as a whole)

Simultaneous presence of these design principles make them inseparable and therefore they can be thought of as a single design principle, i.e. SUM (Scalability, Universality, and Modularity).

### Solution to Problem

The solution disclosed here (are first designs consistent with the SUM principle, addressing a hierarchical matrix of decisions and choices to optimize the business or any process within it as a whole. Therefore the first key aspect of the solution is to integrate all decisions in a hierarchy. However, SUM dictates that any subpart of the hierarchy can be treated as its own separate hierarchy. Every decision or objective is part of a bigger objective (typically over a longer time horizon). The processes and methods to attach and detach such systems are hereby disclosed as well.

Another aspect of the invention is a framework for human-AI collaboration. The paradigm shift with this technology is to swap the role of humans and AI system. Instead of the AI system helping the human making the analysis he or she would like to carry out, with ii the human helps the system for the system to do the analysis it wants and to find and make the optimal choices. This is in contrast to IT systems as we know them all today such as in business intelligence and decision support systems. Therefore, ii systems can be considered complementary to traditional planning and decision making systems where humans decide to carry out many different analyses until they settle on some results. An ii system can suggest alternative plans, choices, settings etc. along with its internal explanations in terms of various objective values and where its settling the balances among complex tradeoffs. Outputs of ii-systems can be also be readily executed on as well similar to control systems, should a human decision maker design it that way or allow it that way.

### INDUSTRIAL APPLICABILITY

Generally, the systems and architectures disclosed here possess properties that make them applicable to any autonomous enterprise of the future in which almost all humans and robots are augmented with such AI agents, systems or capabilities. The network embodiment can be applied to optimize operations in a network such as in the process industry, supply chains and product delivery value streams, power networks, water distribution networks and transit networks, smart city, software control, etc.

In all these cases, there exists many tradeoffs of various kinds and degrees of significance (resulting from double constraints, triple constraints and so on). These tradeoffs interconnect almost all decisions. Making optimal decisions would boil down to finding operating points or making choices that optimally balances these tradeoffs. However, the balance points are wild moving targets. Moreover, the objectives themselves or variables within them are dynamic which means the very definition of optimality may stochastically change and there is not yet any technology to address them even with modest requirements on SUM. The intent with this disclosure on integrated intelligence is to fill this gap.

A system that “integrates intelligence” in this manner would allow to increase efficiency and effectiveness without adding or investing on any new physical infrastructure, and just from digital optimizations. As the number of components in operational systems and networks starts to rise, our handle on its optimality (using current methodologies and technologies) starts to diminish pretty quickly. Therefore there is a lot of “waste” that could be eliminated in open operational systems such as in product delivery value streams. This “waste-elimination” leads not just to lower costs but can also open doors to expanding service. In finance terms, it can boost both top and bottom line of an enterprise just from mere optimizations and executing on better alternative settings, plans or policies generated by an ii-system.

Apart from obvious business advantages in making more optimal choices, there are many other by-product technical advantages that is mentioned throughout the detailed description below.

### BRIEF DESCRIPTION OF DRAWINGS

FIG. 1a) An ii unit, building block, system of human, agent, and a set of decisions or objectives

FIG. 1b) Example of an implicit structure—separate ii systems representation (Universal Architecture)

FIG. 1c) Example of an explicit structure—internal structure of a single ii system

FIG. 2a) A decision/objective (D/O) graph with the head node as the ultimate objective

FIG. 2b) Any hyper-edge in the D/O graph constitutes an ii system

FIG. 3a) Demonstrates a detaching process to create a separate ii system with smaller scope

FIG. 3b) Demonstrates an attaching process to combine two separate ii system into one with larger scope

FIG. 4) Demonstrates an embodiment of an A_il agent

FIG. 5) Represents the universal workflow of an A_il agent to fulfill its tasks dynamically and optimally

FIG. 6) A category of embodiments for network applications and optimization of operations

### DETAILED DESCRIPTION

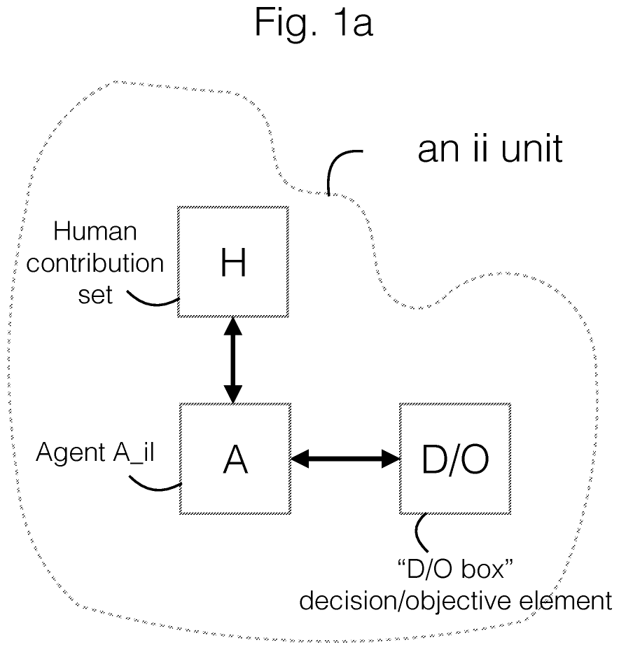

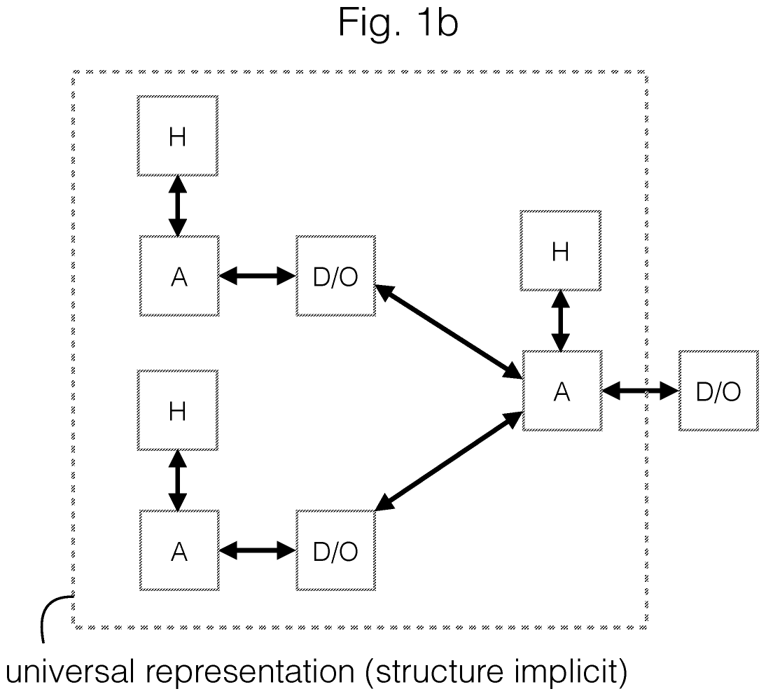

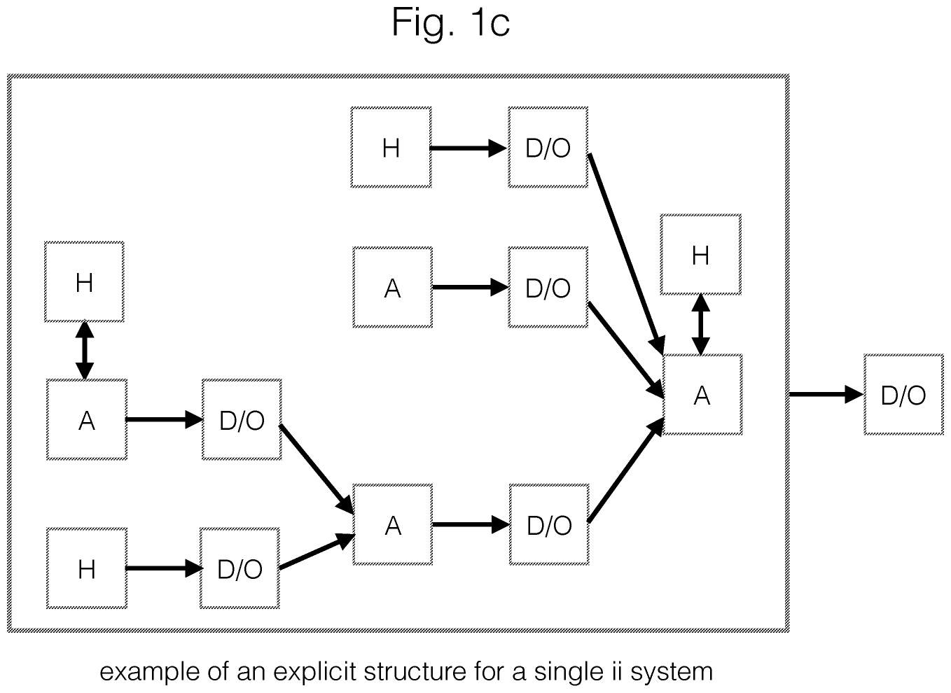

In FIG. 1a, “D/O” represents a decision or objective. “D” is intended to be an abstraction of the form determine, devise, or decide. Similarly, “Objective” is a broad abstraction covering answers to a question, setting a control variable, predicting some value or measuring uncertainty in a value, etc. From a mathematical perspective, O is a function or functional (i.e. functions of functions in the sense of variational calculus) of a set of decision or control variables, i.e. the D set. The “D/O box” can represent a set of dependent or independent D/Os bundled together. Note a set may have only one member, and a function may be single-valued therefore indistinguishable from a scalar value. Here and throughout the rest of the disclosure, all mathematical objects such as sets, functions, functionals, functional operations can be represented by their counterpart computer program, process and memory.

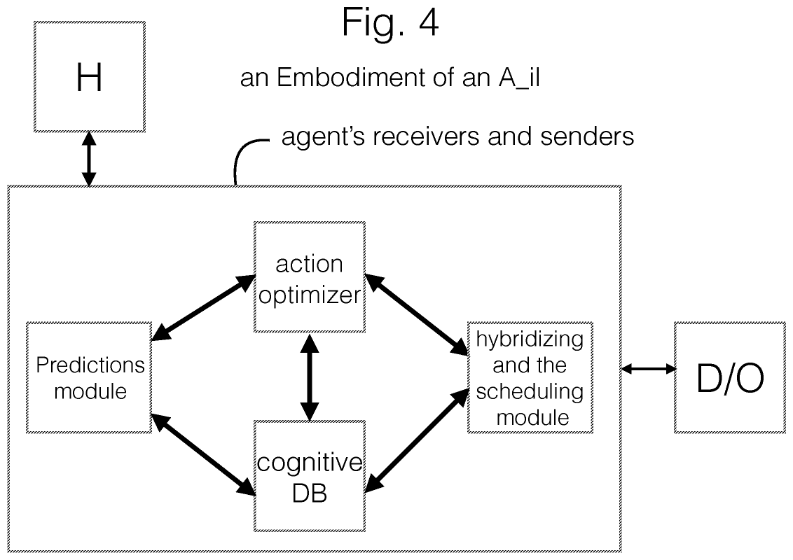

Box A represents an AI agent i at level l (A_il), which is tasked to set the associated D/O set. FIG. 4 demonstrates an embodiment of such agent A. The D/O is set differently at different times and conditions which collectively define the “context” for A_il comprising of any input to the agent including all perceptions on environment, constraints, its memories and the optimization process and variables in agent A_il. Agent A_il can then be considered a mathematical function, mapping the context to D/O. We refer to this function as the function of A_il. And throughout this disclosure “conditioned function” refers to a function that is derived from A_il by fixing or constraining some or all of its context.

The H box represents human contributions or contributions/interactions from/with other systems hooked in by a human. These contributions can broadly range from setting high level objectives, passing through a piece of data, choosing weights or preferences, hand-designing an objective function, to setting a fixed policy or heuristic to fully determine the D/O set (hard-coding solutions) rendering the task of box A trivial.

It is important to note that the execution of suggestions by any A_il (the D/O outputs) is not part of Agent A_il. That is, the permission to directly control an executor or actuator system is beyond ii systems. This is irregardless of the fact that the executor or actuator could be participating in the H box or be receiving (or have access to) the D/O set from the ii system.

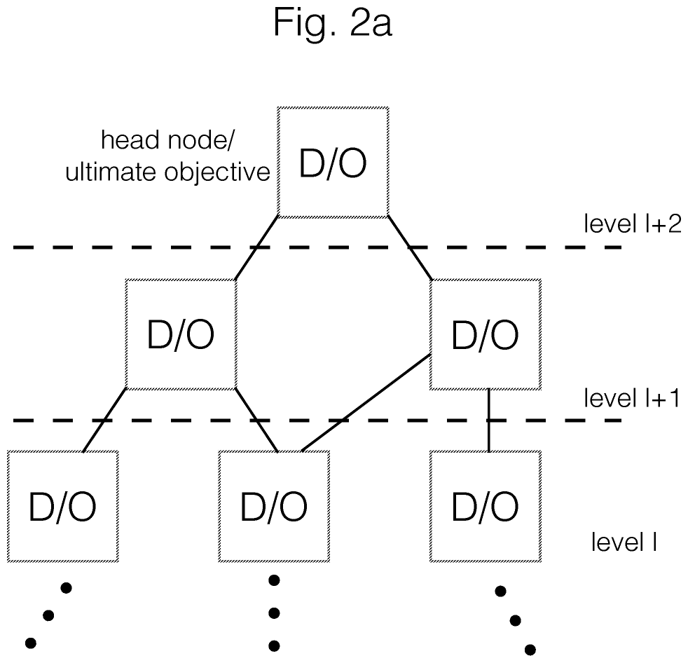

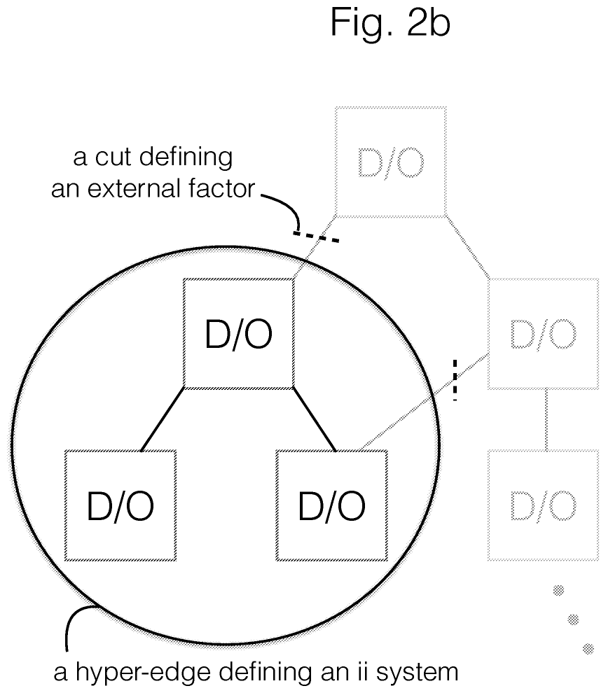

Every D/O ultimately serves a higher level D/O in any entity. Higher level is defined by longer associated time horizon of optimization or objective. Setting up a hierarchical graph of D/Os in a format similar to the one in FIG. 2a. is a crucial first step. Such a graph can be produced by a separate technology, additional component that learns the graph or simply by a collaboration between domain experts, data scientists, mathematicians, and decision makers as they all contribute to establishing this graph by going through a list of questions people or machines have to answer in order to run a company/process or any subpart of it. This process continues by breaking down or building up D/O boxes as needed. Any connected set of D/O boxes to be set by AI, defined by a hyper-edge on D/O graph constitutes an ii system. An example of such hyper-edge is demonstrated in FIG. 2b.

Different embodiments of (graph) connections between the nodes (agents) only differ in the “contextual functional operation” (CFO) that takes place along that connection. Contextual functional operations are mathematical operations performed on a conditioned function. These operations can be any composition of Inf, Sup, Max, Min, Gradient, higher order directional derivatives and similar operators, for instance Gradient of Max of a conditioned function with respect to a variation in context. In the preferred embodiment, agent A_il can request result of a CFO on a conditioned function of any agent of level k (with k<l) to which A_il is connected to, by providing the conditioning context as well as the functional operation to be performed on the conditioned function.

In order to set the initial graph, 1) an initial set of D/O are compiled 2) the set is divided into several levels. The levels are separated based on at least one of these following metrics: cost function values, time horizon length (inverse frequency of D/O output), (cumulative) energy-scale of the operation/process under influence by the agent. These metrics should be roughly equivalent in terms of the levels they generate. Deviations are either resolved by taking the overlap (merging levels) or further branching (splitting level or removing the degeneracy that may exist in levels based on any single metric). 3) inter-layer connections may be setup in any hybrid of bottom-up or top-down approach based on the definition of each D/O, this is an example contribution of the H boxes. 4) intra-layer connections can initially be setup by the definition of states and D/O of a an agent as decided by the H box. However, these connections can be added or removed by another agent of a higher level. Intra-level connections can provide cost or reward rate information for the objective function of an agent in the same level. This helps to auto-construct the objective function of the agent more efficiently and provides a built-in design for explainability to human decision makers (i.e. a white-box transparency). However, cost or reward rates, weights or coefficients are among the information or data types that are not necessarily addressed by the D/O graph and hence they may come from a system or node with a level different than the level of the objective function O, in which case it does not constitute an inter-layer connection in the D/O graph by itself.

If every ii system contained a single AI agent, one can connect them in a universal architecture consistent with the D/O graph, represented in FIG. 1a. This allows for extensible implementation with physically separate systems for each ii node. However, as mentioned above, one must note that the D/O graph represents only one type of information exchange among such systems, the full network of information exchange can be arbitrarily more complex via various protocols such as broadcasting types and so on. FIG. 1c. demonstrates an example where the D/O structure is implemented by internal structure of a single system. FIGS. 1b and 1c can be considered equivalent representations and therefore there exists a freedom in choice of physical implementation boundaries.

This kind of hierarchy allows for ii systems to have:
A high flexibility in limiting or expanding their scope
A pre-designed ability to be augmented later by hooking two or more systems together and allowing for cross-optimizations and higher intelligence,
Higher transparency, maintainability, explainability, auditability (in contrast to most black-box AI approaches/systems).

Segments of this hierarchical graph can get corrected or expanded gradually over time. This is part of why the ability to augment and expand these systems easily is of critical importance.

This structure also surfaces boundaries for human-AI collaborations and mutual augmentation. The AI is augmented by 1) assistance in regularization for machine learning (ML) processes. This can manifest in many different forms. For instance, structural regularization is an essential one such as the one supported by the D/O breakdown process mentioned above 2) assistance with the objective functions, including setting explicit optimization functions, constraints, world models, etc. 3) being complemented with the information about the world beyond the substrate world model that AI does not possess, which maybe in common sense reasoning or various judgment calls, etc. 4) support for any-time algorithms in AI in various time-bound settings. Equivalently, the pros offered to the human set are 1) ability to enforce the good solution they are aware of or strongly prefer. 2) structuring the system to amend to people's manner and choice of conduct as much as possible 3) ability to handle much higher level of complexity with the system or a much more enhanced ability to cope with complex systems than otherwise 4) minimization of effects from well-documented human irrationalities and other shortcomings in optimal decision making.

In FIG. 1a. the double-sided connection between the H and A boxes is meant to signify this collaboration.

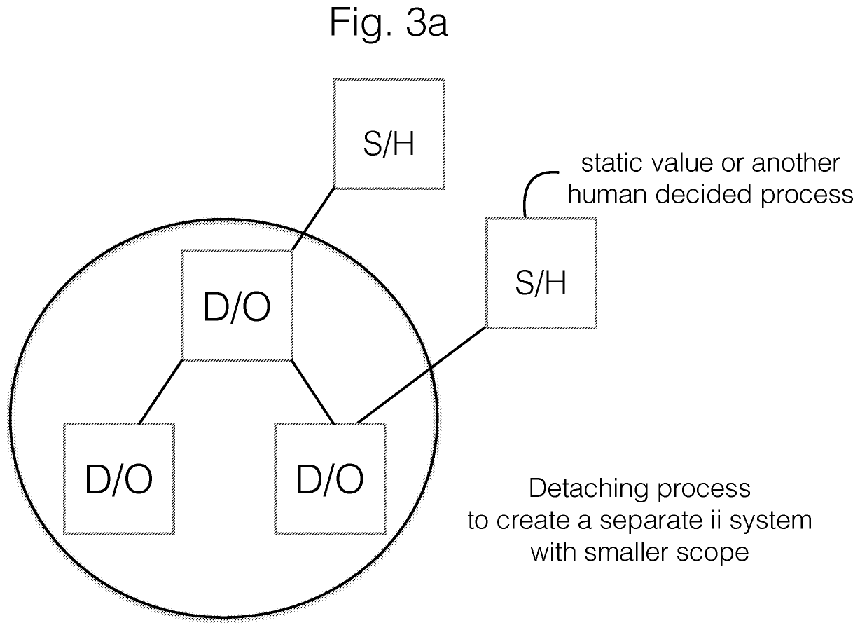

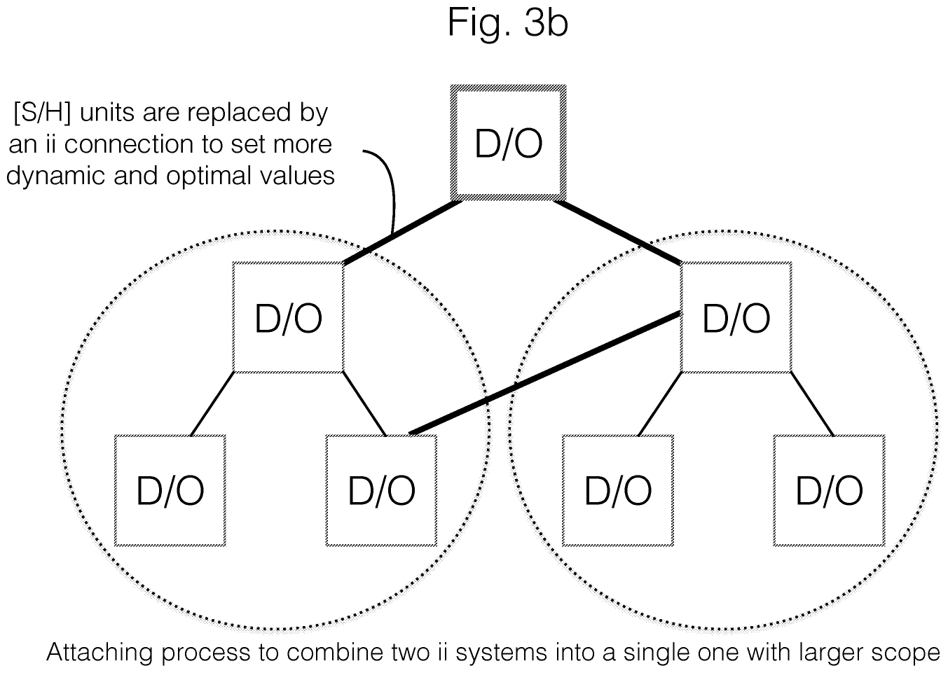

ii systems can break down to smaller ii systems (detaching process) or join to form a more comprehensive ii system (attaching process). FIG. 3a, shows the detaching process where an ii system (target) can be extracted and isolated from a bigger system. This is streamlined by a two step process: 1) cutting the D/O connections between any D/O box inside the hyper-edge defining the target ii and any D/O box outside of it. 2) supplying the cut connection by either a static value or assumption or another process that the human expert may define, and this constitutes an “S/H” box. By doing so, one is effectively reducing the scope of the target ii system relative to the parent system it was detached from.

FIG. 3b, shows the attaching process where two ii systems can be combined to form a bigger system. This is streamlined by replacing S/H boxes or elements supporting one ii with a corresponding node in the other ii, for any S/H that a correspondence does exist. The process can go as follows: suppose (without loss of generality) that the head nodes of two ii systems are of the same level, l. Level l+1 is created with a new D/O box at this level (l+1). Next, the head nodes of both ii systems are connected to this new head node (at level l+1). An S/H box of one ii system with a connection to an existing corresponding node in the other ii system, is replaced by the cross-connection. This results in a single ii system that is larger in scope and optimality than each merging u system alone. Therefore two separate ii systems that are developed to optimize different parts of the host ecosystem can be attached to one another and form a more comprehensive and optimal ii system. Hooking them up will not only empower each but it can achieve greater overall results that neither one could alone.

This process goes essentially the same for attaching two un-level ii systems or attaching more than two ii systems. It also extends to insertion of a new level in between two levels. For example consider a simple ii system with 2 levels, 4 nodes in level 1 and 1 node in level 2. The 4 nodes in level 1 can be grouped into 2 pairs and a new node could be assigned to each pair in a new level between 1 and 2. The resulting ii system will have 3 levels, 4 nodes in level 1, 2 nodes in level 2 and 1 node in level 3. Although this mid-level insertion process does not change the overall scope of the ii system, it may improve its practical speed and performances such as in learning, optimality, stability, maintainability, etc.

Similarly, a multi node and multi-level ii system can be collapsed into a single agent, replacing its place in the larger graph with a single node in the level of its original head node, and preserving the same connections. For instance, a collapse is possible in cases where it's realized that a particular set of nodes could be replaced by a hierarchical reinforcement learning (HRL) agent. Description of FIG. 4 makes this clearer.

These attaching and detaching mechanisms are not to be taken as integrating systems as it's known in the IT domain, such as in real time systems and to have the most up to date information. Processes described here are about simultaneous optimizations and incrementally considering more factors and tradeoffs to address optimality in complex systems in uncertain environments.

To illustrate this further and describe an embodiment, consider two ii systems represented by the overall objective of their head nodes (both at level l) denoted by two functions f:Dᵢ→D_{f} and f′:D_{i′}→D_{f′}. Further suppose, f is a context variable for f′ optimization and vice versa, i.e. f ⊂ {i′} and f′ ⊂ {i}. In the detached case, even though the two systems need to be integrated in the IT sense Consider 4 different ways of doing this:
A. (Detached) Systems are integrated, but no their intelligence i.e only able to see each other's results for their context. That is f and f′ are optimized separately and their output are acted upon and read by other operations.
B. They are attached through a node (g) created at level l+1 that dictates only the order of optimization and execution between f and f.
C. They are attached through a node created at level l+1, with the objective function g=g_{f}(f, f′(f))=g_{f′}(f(f′),f)
D. They are attached through three nodes at level l+1, represented by the overall objective c(f), c′(f′), and g=c(f)*f+c′(f′(f))*f′(f)=c(f(f′))*f(f′)+c(f′)*f′. Wherein, c and c′ can represent the normalized cost or value for g, of f and f′, respectively.

Attaching process in B, C, and D result in systems that are different than a multi-component system such as in integrated systems. In this sense ii systems of B,C, and D are systems of integrated intelligence.

As mentioned above a collective set of D/Os generated by ii systems can constitute alternative plans, choices or settings to what would have been followed otherwise. This alternative set is automatically generated and is by-design capable of providing visibility on why a certain set is being suggested, by providing evidence on showing how it is more optimal. This is possible through the “g” function values that the system settles with, for instance in B, C, D scenarios above. The g function can be self-constructed using machine learning (ML) techniques by providing it with samples of values of g or some other feedback such as error feedback on g values. In case of scenario (D), c and c′ can represent head nodes of two other ii systems (that are at the same level as g and we are connecting them to g by intra-level connections), in which case g can be auto-constructed by linear combination of nonlinearities. Non-linearities can come from calling c and c′ values or functions with a context.

Attaching more than two ii systems together can proceed in two ways. One would be by means of attaching two at a time based on procedures discussed above. Maximum number of unique mergers for attaching N ii systems in this fashion is N!2^{N-l}, each representing a different representation of the function “g” representing the head node of the emergent ii system (from attaching N ii systems). The other way would be to add one node in a level higher than the highest level of N ii systems and connecting all N head nodes directly to this node in the resulting D/O graph. The total possible unique representations of the “g” function representing the head node of the resulting emergent ii is N!. For instance in combining 3 ii systems (f₁, f₂, f₃), one representative “g” for the combined system could be g_{f}_{ₗ}=cₗf₁(f₂(f₃),f₃)+c₂f₂(f₃)+c₃f₃. However, utilizing the information of the existing D/O graph for instance the “level” information and semantics of the D/O sets, can set up a trivial route for combining the N systems.

One can in fact show that neural networks are only special case of ii systems presented in this disclosure. For instance feedforward neural networks, can be represented by an ii systems where each neuron is a node in the ii system and its activation is the node's D where incoming weights to a neuron are present inside the O function of the node. A backpropagation algorithm is effectively worked out by the functional operations on the O functions which triggers processes such as backward and forward mode accumulation in automatic differentiations.

It is important to note that g and the functions fᵢ that the “g” functional is comprised of, do not have to be differentiable. They only need to search the space of configurations by the use of some functional operations (any that would allow them to). Of course, if they are differentiable functions and functionals, various techniques in differentiable programming can be the preferred approach. A popular choice for derivative-free approach is via instances of evolutionary algorithms. In case of long run-time problems with evolutionary methods, hybridization with gradient-approximation methods can be a solution.

In these attaching processes, the merging node, represented by g in the cases discussed above, can be thought of as the agent that facilitates marching towards a more optimal output for the overall system. It is important to note that the requirement for node g is not necessarily to find a provable global optima for the full combined system (as it may not meaningfully exist given the true constiants of the open and time-bound real-world system), but to improve upon the non-attached collective solutions. A methodology that can lend itself well to these situations is the class of MM algorithms for g, in which case it is provably guaranteed that g will never worsen the situation (in the attaching process) in every iteration of the optimization attempt. This approach is also applicable to discrete cases (non-differentiable) where the surrogate functions can be smoothly differentiable by construct. These methods can further be combined with embedding techniques, especially in creating differentiable representations of discrete objects.

This marching towards a more optimal output for the overall system of multiple agents may remind the reader of game-theoretic scenarios where analysis of the system as a whole attempts to find an equilibrium points such as a nash equilibrium if it exists. These cases although subsumed in ii framework disclosed above, do not represent the intentions of an ii system and the problems that it uniquely tackles. An important assumption for an ii system is existence of an ultimate objective (even if partially specified) or reference for the system as a whole, i.e. the head node would decides on the preferences of the system as a whole. For instance if the whole system is composed of several agents participating in a competitive game, the head node decides whether a Nash equilibrium would be desirable or not, as it assumes it's own higher level objective function (representing a “bigger picture” if you will). Therefore the intended utility of ii systems is not for scenarios that can be sufficiently well addressed solely within the paradigm of game theory and an ii system is not to represent multi agent games without any oversight preference independent of D/O of player agents. Although the ii framework can provide many benefits in the case of cooperative games, the intended target applications are in scenarios where game formulations are either not possible/practical or highly inefficient. Scenarios where different agents in the full system are not explicitly aware of the tradeoffs and objectives of one another. In this case, solution would be by “integrating intelligence” of various agents and decision or control variables, i.e. a sweet spot for employing an ii system. These scenarios constitute vast opportune areas in all kinds of enterprises and are currently either not addressed or only by limited heuristics.

The case of competitive games should be handled and represented by one agent/node in the D/O graph. To make this clearer, consider the case of generative adversarial models (such as the family of generative adversarial networks). This is an example of a competitive game setup with a higher level purpose which is to have a generative model, generating observations and data that have not yet occurred, or been seen/observed but they could have. For instance, generating a facial image of a person that has never existed. The generative models are of extremely abundant utility in implementing various parts of an AI agents workflow. However, the models that compete in order to create a good generator model as in GANs, by themselves are not good candidates for two separate AI agents in the D/O graph. A better setup would instead be to represent the utility of both the discriminator model and the generator model (that are co-trained in the case of GANs) in the D/O set of a single AI agent.

A similar situation arises in multi-criteria decision making (MCDM). Such scenarios can be cast into an ii system where a higher level agent is tasked with finding a balance between multiple criteria. However, this is better suited to be a task of a single AI agent using various techniques in the field of MCDM as otherwise all agents would be trying to choose from the same set of choices (for D) except with different O functions. In the case where the human end user is providing preferences or some other set of values directly guiding decision making, which is the typical case in MCDM, the advantages of an ii framework is not utilized. This is because the bottleneck would not be in integrating intelligence but to capture the correct direct preferences and making sure the output suggestions are guaranteed to be consistent with the input preference set.

FIG. 4. demonstrates an embodiment of an A_il. The agent's boundary represents all its receivers and senders, all its integration points to the outside world. This includes its (software) sensors, data receivers or listeners. A “listener/watcher” is implemented by a piece of software that is running a continuous process to detect the outside world and any detected piece of information is passed to a perception module and then to any of the four elements in the depicted inside the A_il in FIG. 4 or directly to them. Obviously each of the 4 elements, can have their own receivers and senders to further filter incoming or outgoing communications. Furthermore, all observations, data and results are recorded in the cognitive database unit.

A cognitive database (CDB) is defined here as a memory unit similar to a database (DB) with one key difference. A database refers to a software system that is in charge of storage and retrieval of data, typically with a declarative language providing create, read, update and delete operations on data elements called records. This language works based on exact matching with records stored in the database. A cognitive DB differs with a DB in the sense that it works based on in-exact matching, where it can provide information that are not exactly matching the queries asked of the system . This is done by some measure of similarity. This unit can be implemented in a variety of ways using various similarity concepts and measures for instance in graph database or alike.

The presence of CDB in each agent is a key aspect of this invention where data and models are much more tightly integrated. The distribution, representation, storage and retrieval of data here are influenced by the agent and are serving the unique D/O responsibilities of the agent. In contrast to the case of mainstream AI modeling where the deployed AI model is decoupled from the data is was trained and tested on.

The prediction unit is a unit where the complex ML models are formed to predict a set of values, functions or future states of a simulation (or world-models). The output of the prediction unit is used in the process of the action optimizer unit and the output model itself can be deployed inside the CDB unit. The prediction unit provides the ability to analyze the data that constitutes the environment and the context of agent A_il (such as time-series data on the variables of the operations under optimization). This unit can reveal and latent variables behind them observed signals and data, which can then be stored in the CDB unit range.

An effective choice for the predictive unit is a hierarchical hidden markov model (HMM) unique to the agent. Set of future rollouts (e.g. forcasets) and the associated confidences are communicated to the action optimizer unit.

The action-optimizer unit is the unit where an optimization problem is constructed given the D/O set and all the other inputs. In agents where the sole responsibility is prediction of leanable values or functions, the optimizer unit is trivial and implied in the prediction and CDB units. For cases beyond prediction, a simple yet highly applicable embodiment for this unit can be via setting up and solving a model predictive control (MPC) with horizon (T), where T itself can be dynamic. For the case of explicit optimization equations a solver mechanism can be employed to find solution to D/O set. Methods such as linear programming; mixed integer linear programming, disjunctive programming, quadratic programming and so on can be effective choices. Automation and improvement of the process of this unit is facilitated by the information provided to it by all the other elements in the agent. For instance latent variable information and degrees of confidence by a HMM model produced by the prediction unit can significantly improve the effectiveness and quality of the action optimizer unit.

In the case of implicit optimizations such as in RL formulations, various RL techniques can be used to learn good value functions or policies from which optimal actions are drawn. Implicit refers to the fact that this class of optimizations are based on experiential learning to act optimally in the future, instead of directly optimizing an “equation of future” or working with the true distribution where past and future data come from. Model-based RL can be facilitated through models produced by the prediction unit and model-free RL can be facilitated by the CDB unit where all types of counts can be queried including empirical counts and pseudo-counts.

These counts (and pseudo counts) and models in CDB of situations that have occurred in the past can be used to directly reason about suitable actions in a current context. The hybridizing module can combine such a result from CDB with that of the optimizer unit to set the final output. The other significant feature provided by this module is facilitating an anytime responsiveness, i.e. an anytime algorithm. In many real-world situations the delay in response is a hidden cost term in the true objective function and optimality of D/O must consider the cost of running time. This aspect of optimality is an essential role of hybridizing and scheduling unit.

One cannot possibly model everything (or think of modeling ahead of acting) in a dynamic world. Anything that is not modeled or the models have “forgotten” about, the CDB unit can provide an answer to by reasoning based on similar cases without any predetermined model. This is another reason for implementing a hybridization unit.

All units inside an agent including both optimizer and CDB have their own controller and processors. Hence, the other role that this scheduling unit plays is in balancing the internal tradeoffs in learning and resources of the agent A_il itself.

In FIG. 4. the H box can interact with all these components of agent A_il discussed above. Common example choices among this H-set can be
in supplying the value of any variable, ranging from a fixed value to a fuzzy preference or judgement specification,
a set of equations describing the system dynamics,
a pre-built machine, system or model that specializes in providing specific information, such as a world-model,
a complementary heuristic-based or rule-based system, and so on.

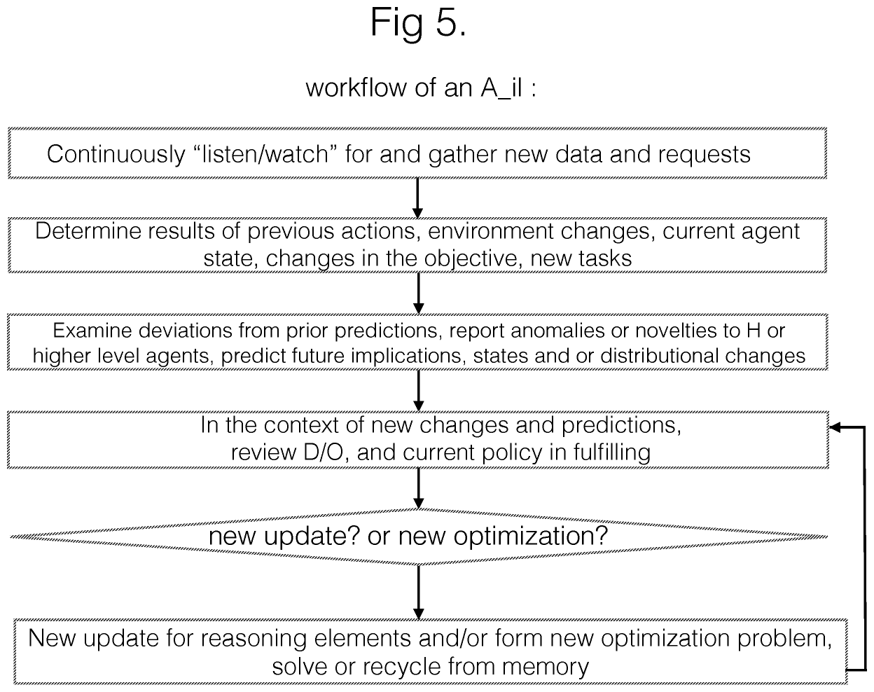

The workflow for this A_il is as shown in FIG. 5:
1. Using the receivers at the boundaries, agent A_il continuously “listens/watches” for and gather new data and requests. Example of such data are elements that form the state of an agent such as its experience of the environment, and just the state of the environment that can come from other data collecting systems such as edge, cloud or an operational database, etc. Example requests are a functional operation requested by a higher level agent or even modifications in the D/O set of A_il.
2. Any resulting information is handed to the CDB unit to be recorded (as raw or transformed) or discarded. This allows CDB to determine current results from previous actions, environment changes, current agent state, changes in the objective, and new tasks at hand.
3. Prediction unit along with CDB can predict future implications, states and potentially distributional changes. Deviations from prior predictions can be examined to detect and flag anomalies or novelties that can be reported to the H Box or a connected agent at a higher level (>l).
4. In the context of new changes and predictions, the agent can determine how well the D/O set is being fulfilled by the current policy and whether there are any changes in the D/O set itself based on higher level requests. This can provide benefits over time horizon optimizations far beyond a fixed time horizon, i.e the case for an MPC formulation.
5. Based on the results of previous steps, the agent determines whether a new update or new optimization for the D/O set is needed. An update could be modifying D/O values without further internal optimizations. An example can be in taking options in an options network over Markov decision processes (MDP).
6. Last part is to form new updates or optimization problems and solving or recycling from past solutions in CDB. Going through many optimizations over fixed or variable time steps provide opportunities for optimizing the optimization process itself which is facilitated here by a cognitive memory of these (past) optimizations in CDB. This can also prove necessary in satisfying any-time algorithmic requirements, which is handled by the hybridization unit.

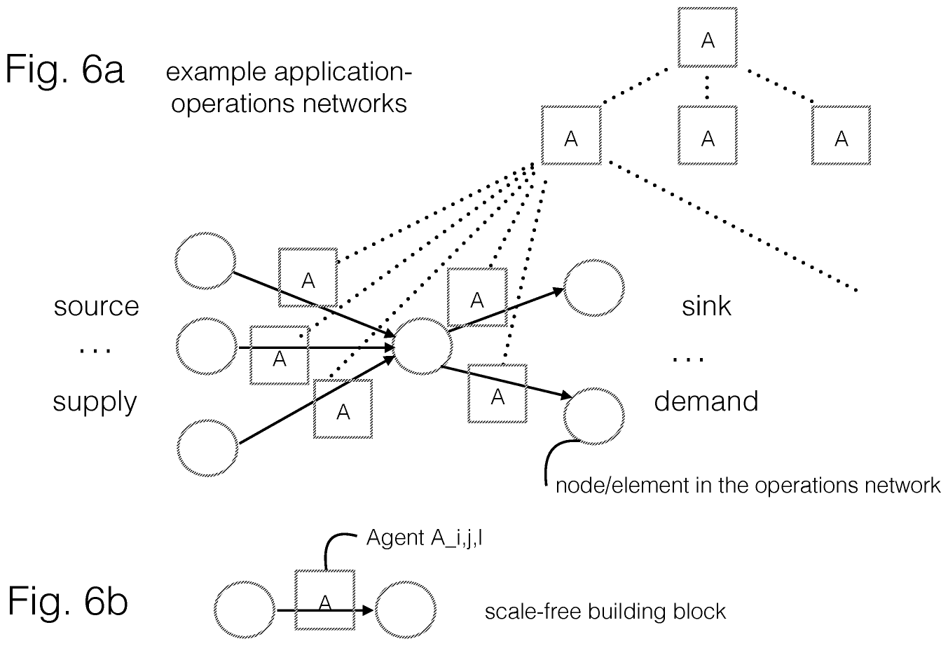

FIG. 6a depicts an embodiment application in operations networks, where there is a natural network flow in at least one of the layers, i.e. a source to sink flow. Natural network structure is shown by circles representing nodes/elements in the operations and each square with letter A, represents an AI agent.

Example of such natural flow can be in supply chains and in product delivery value streams in general (supply to demand flow). The emerging state of operations in these networks and industrial value chains in general are very complex, dynamic and not fundamentally understood. The result is that there is no known optimal or universal solution to achieve the industrial goals, i.e. higher efficiency, lower costs, higher quality, etc. The first approach is to develop some intuition using experience and common sense to regulate the (emergent) behavior. Examples are heuristics such as do not let the inventory of X be higher than Y or lower than Z. However, this approach can lead to unexpected, undesirable new behavior. New rules must then be developed to regulate the new behavior. This leads to a proliferation of rules or models, while not only the optimal operational conditions are not achieved, the overall productivity and efficiency starts to decline. Organizations realize variability is the enemy in optimizing their operations, but it cannot be eliminated. Therefore, best approached by reducing sensitivity to variability.

The problem is that lots of heuristics (that don't consistently work) are what is currently being used to plan and execute operations. The cutting edge efforts amount to use of AI models that are limited to very specific functions and datasets. Since these models are each designed with a different narrow scope in mind they cannot address the sub-optimal condition of the system as a whole, while the human decision maker needs to make the right decisions from moment to moment at scale and speed. Such sub-optimality can be addressed by an ii system introduced in this disclosure. FIG. 6a Embodies a system where AI agents not only learn the dynamics but continuously vary policies in real-time with variability induced on the business and the operations. Dotted lines represent exchanges along the D/O graph. The figure illustrates the distribution of AI agents on every link from low-level (physical) operation to higher-level connections in operational units and business elements involved. Low-level agents are responsible for decisions such as what needs to be moved along or produced, when and how, along an arc or region. Example of a higher-level decision is the break-down of such region or decision boundaries for lower-level agents. Example of such a decision can be to enforce the agents that have the longest lead-time and are closest to the demand, optimize and forecast first. There is no agent that fully controls other agents. Agents use a variety of inputs and sources. Some can be unique to them such as their own history in CDB (observations of what happened/what were the conditions, what the agent did about it and the outcomes) or other predictions from their prediction unit. Other input can be from other AI agents or various enterprise and operations systems (both real-time and not). By utilizing such collective learning, the system can continuously drive improvement and reduce sensitivity to variability.

FIG. 6b represents an abstract building block of the network of agents A_ijl (where i, j, and l encode position in the hierarchical graph network) and signifies that this architecture has a SUM-compatible design and hence, the solution allows for it to be indefinitely scalable and flexible. This architecture provides natural logics for data distributions as well as opportunities for near-data-processing optimizations. More importantly, it allows for construction of explainable AI system which are essential in many cases. Even if one chooses to employ popular black-box end-to-end ML techniques such as deep Q networks (DQN), in an ii system every agent would be having a unique DQN for a different purpose and using the data and inputs that are proportionally different. This distribution allows for higher transparency, maintainability, explainability, auditability.

The following is to further clarify the uniqueness and domains of utility of this disclosure. An ii system is uniquely targeting applications that would otherwise be assigned to more than one person or robot, which can be simply due to physical distribution of tasks or decisions or the complexity of them. Improvements in AI techniques do not affect this need for a distributed D/O network, instead they should improve each node or restructure the nodes through primitives processes described above. In fact, an aspiration with this disclosure of integrated intelligence is to help create a new field that may be best described as “non-monolithic AI”.

To compare the AI techniques used here with those in mainstream AI such as in deep learning, note that these mainstream learn to search over the space of circuits (parameters) that define a function, mappings from a set of inputs to outputs. Meta-searches such as in automated ML, can also be considered “circuit-search” techniques. Whereas an ii system, can represent (fuzzy and non-differentiable) functionals to search over the space of functions to improve optimality of an (often open) system made of many functions as a whole. The ii setup described above does not impose fundamental restrictions on removal of hand-designed elements or various forms of priors provided by domain experts. All elements are in principle auto-learnable, yet practically, human judgment and expertise must be supplied in such open systems with wide scopes. Therefore the human-AI collaboration remains a critical aspect of this design.

What is claimed is:

1. An AI system for dynamic decision making, embeddable in a hierarchical network of AI agents, the system comprising of
a plurality of receiver units for obtaining information, a set of data, context objects and requests;
an action optimizer unit;
a unit for outputting decision and objective functions with context (D/O set);
a unit fulfilling requests on performing functional operations on the D/O set.

2. System of claim 1, further comprising of a cognitive database (CDB) unit; or a unit that communicates with a separate CDB system holding at least partial information about experiential memories of the agent in the system of claim 1.

3. System of claim 2, further comprising of a hybridizing and scheduling unit.

4. System of claim 1, further comprising of at least one interface to establish communication with a human or a separate system designated by the human.

5. System obtained by a composition (attaching process) of a plurality of systems of claim 1.

6. A system for optimization of complex systems that can offer alternative choices and plans dynamically, the system comprising of
a plurality of AI systems each with a specific D/O set and the ability to perform functional operations on its D/O functions and providing the result of the operation to another AI system in the plurality set;
a graph of these D/O sets, a unit that determines how the D/O sets are related; and
an output unit for displaying or communicating the resulting D/O set.

7. Systems obtained by any of the following processes:
a composition (attaching process) of a plurality of systems of claim 6,
a decomposition (detaching process) of system of claim 6,
new node or level insertion (insertion process) in system of claim 6, or
merger of a plurality of nodes into one (compaction process) in system of claim 6.
